(19) United States
(12) Patent Application Publication
(10) Pub. No.: US 2020/0086885 A1
(43) Pub. Date: Mar. 19, 2020

(54) Vehicle Control Device

(71) Applicant: Hitachi Automotive Systems, Ltd., Hitachinaka-shi, Ibaraki (JP)

(72) Inventors: Naoki HIRAGA, Hitachinaka-shi (JP); Toshiyuki INNAMI, Hitachinaka-shi (JP); Junya TAKAHASHI, Tokyo (JP); Yuki AKIYAMA, Tokyo (JP); Seiichi SATOH, Hitachinaka-shi (JP)

(21) Appl. No.: 16/616,197

(22) PCT Filed: May 30, 2018
(86) PCT No.: PCT/JP2018/020662

§ 371 Date: Nov. 22, 2019

(30) Foreign Application Priority Data
Jun. 15, 2017 (JP) 2017-117340

(51) Int. Cl. B60W 50/023; B60T 17/18; B60T 8/96; B60T 8/1755; B60W 50/04; B60W 10/18; B60W 40/109; B60W 40/114; B60W 30/02

(52) U.S. Cl. CPC B60W 50/023; B60T 17/18; B60T 8/96; B60T 8/1755; B60W 50/045; B60W 2520/14; B60W 40/109; B60W 40/114; B60W 30/02; B60W 2550/10; B60W 10/18

(57) ABSTRACT

According to the present invention, even when information needed to calculate an acceleration command cannot be detected due to a sensor malfunction or the like, acceleration control can be continued by adding, in accordance with outside-world information, a correction to the result of calculating the acceleration command, which uses the result of an estimation made using alternative sensor information. The vehicle control device of the present invention comprises a vehicle behavior information acquisition unit 31 that acquires vehicle behavior information including lateral movement information of a vehicle 0, an acceleration control unit 39 that controls acceleration in accordance with the lateral movement information acquired by the vehicle behavior information acquisition unit 31, a diagnostic unit 37 that diagnoses whether or not there is abnormality in the vehicle behavior information and outputs diagnostic information, and an alternative possibility assessment unit 38 that assesses whether or not alternative control is possible on the basis of the lateral movement information and the diagnostic information.

### TECHNICAL FIELD

The present invention relates to a vehicle control device.

### BACKGROUND ART

A device has been conventionally proposed which performs acceleration and deceleration similar to those performed by an expert driver by acceleration control based on a lateral jerk generated by a steering operation of a driver (PTL 1). A method is proposed in which, when control as described above is performed, acceleration/deceleration is performed by estimating a lateral jerk to be generated based on a steering angle or a roll rate, instead of directly detecting the lateral jerk (PTL 2).

### CITATION LIST

### Patent Literature

PTL 1: JP 2008-285066 A

PTL 2: JP 2009-107447 A

### SUMMARY OF INVENTION

### Technical Problem

However, if the steering angle, etc. required to estimate the lateral jerk cannot be detected due to a sensor malfunction or the like, it is impossible to execute an operation for assisting the driver's driving by acceleration control similar to that performed by an expert driver, resulting in that ride comfort is reduced, and avoidance performance when emergency avoidance is needed is deteriorated.

An object of the present invention is to enable acceleration control to be continued by adding, in accordance with outside-world information, a correction to the calculation result of an acceleration command calculated on the basis of the result of an estimation made using alternative sensor information, even when information needed to calculate the acceleration command cannot be detected due to a sensor malfunction or the like.

### Solution to Problem

In order to address the abovementioned problem, a vehicle control device according to the present invention includes: a vehicle behavior information acquisition unit that acquires vehicle behavior information including lateral movement information of a vehicle; an acceleration control unit that performs acceleration control in accordance with the lateral movement information acquired by the vehicle behavior information acquisition unit; a diagnostic unit that diagnoses whether or not there is abnormality in the vehicle behavior information and outputs diagnostic information; and an alternative possibility assessment unit that assesses whether or not alternative control is possible on the basis of the lateral movement information and the diagnostic information.

### Advantageous Effects of Invention

According to the present invention, even when information needed to calculate an acceleration command cannot be detected due to a sensor malfunction or the like, acceleration control can be continued by adding, in accordance with outside-world information, a correction to the calculation result of the acceleration command calculated on the basis of the result of an estimation made using alternative sensor information.

### BRIEF DESCRIPTION OF DRAWINGS

FIG. 1 is a schematic configuration view showing a vehicle to which a vehicle control device according to an embodiment of the present invention is applied.

FIG. 2 is a system block diagram showing a configuration of a vehicle movement control device according to a first embodiment of the present invention.

FIG. 3 is a system block diagram showing a configuration of vehicle movement control means according to the first embodiment of the present invention.

FIG. 4 is a system block diagram showing a configuration of a longitudinal acceleration command value calculation unit according to the first embodiment of the present invention.

FIG. 5 is a flowchart of an information alternative possibility assessment unit in a case where steering angle information has an abnormal value in the first embodiment of the present invention.

FIG. 6 is a schematic diagram of a travel path when a vehicle travels along a curve with a turning radius of 40 m only by a driver's steering wheel operation.

FIG. 7 is a graph showing an example of the behavior of a longitudinal acceleration command when longitudinal acceleration control is canceled in step 107 in FIG. 5.

FIG. 8 is a flowchart showing an example of calculating a correction value of a longitudinal acceleration command by a longitudinal acceleration command value correction calculation unit according to the first embodiment of the present invention, when steering angle information has an abnormal value.

FIG. 9 is a flowchart showing an example of calculating a longitudinal acceleration command by a longitudinal acceleration final command value calculation unit according to the first embodiment of the present invention, when steering angle information has an abnormal value.

FIG. 10 is a graph showing steering angles, yaw rates which are alternative information, and longitudinal acceleration command values, in the cases where steering angle information can be acquired and cannot be acquired.

FIG. 11 is a diagram showing a relationship between a travel path and an obstacle, when the vehicle travels as illustrated in FIG. 10.

FIG. 12 is a graph for describing a method of correcting a longitudinal acceleration command value, when the vehicle travels as illustrated in FIG. 10.

FIG. 13 is a system block diagram showing a configuration of vehicle movement control means according to a second embodiment of the present invention.

FIG. 14 is a system block diagram showing a configuration of a yaw moment command value calculation unit according to the second embodiment of the present invention.

FIG. 15 is a flowchart showing an example of calculating a correction value of a yaw moment command by a yaw moment command value correction calculation unit according to the second embodiment of the present invention, when steering angle information has an abnormal value.

FIG. 16 is a flowchart showing an example of calculating a yaw moment command by a yaw moment final command value calculation unit according to the second embodiment of the present invention, when steering angle information has an abnormal value.

FIG. 17 is a graph showing an example of a longitudinal acceleration command value and a yaw moment command value when the first embodiment and the second embodiment of the present invention are combined.

### DESCRIPTION OF EMBODIMENTS

In a first embodiment of the present invention, longitudinal acceleration control for decelerating a vehicle upon starting to turn a curve and accelerating the vehicle upon exiting the curve according to vehicle lateral movement information (specifically, lateral jerk) acquired from a vehicle behavior sensor will be described as an example of vehicle movement control calculated based on information acquired from an on-board sensor and information acquired from a vehicle behavior sensor.

The first embodiment to which the present invention is applied will now be described with reference to the drawings.

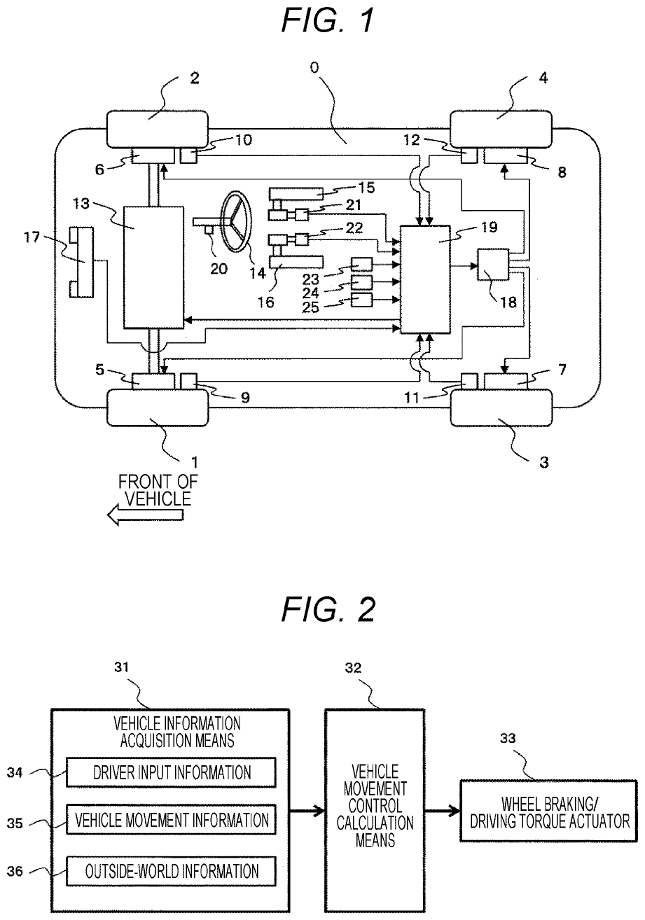

FIG. 1 is a schematic configuration view showing a vehicle 1 to which a vehicle control device according to an embodiment of the present invention is applied.

The vehicle 0 shown in FIG. 1 is a front wheel drive vehicle, and has wheels 1, 2, 3 and 4 on the front, rear, left and right. A rotational driving force from a driving force generator 13 constituted by, for example, a gasoline engine (or an electric motor or the like), a transmission, etc. is transmitted to front wheels 1 and 2. The wheels 1, 2, 3, and 4 are provided with wheel speed sensors 9, 10, 11, and 12 for detecting the rotational speed (number of rotations), respectively.

The vehicle 0 also includes a steering 14, an accelerator pedal 15, and a brake pedal 16, and detects an amount of operation performed by a driver on the respective members by a steering angle sensor 20, an accelerator sensor 21, and a brake sensor 22. The wheels 1, 2, 3, and 4 are also provided with brakes 6, 7, 8, and 9, respectively, so that braking force can be generated on the wheels 1, 2, 3, and 4 according to the value of the brake sensor 22 or a command value from an electronic stability control unit (hereinafter referred to as ESC) 18.

In addition, the vehicle 0 includes a lateral acceleration sensor 23, a yaw rate sensor 24, and a roll rate sensor 25 for detecting vehicle movement information. The vehicle 0 further includes a stereo camera 17, by which forward information such as 3D object data or white line data in front of the vehicle 0 can be acquired.

A longitudinal acceleration command value is calculated by longitudinal acceleration control means 19 on the basis of information from the respective sensors provided to the vehicle 0, and the calculation result is transmitted to the ESC 18 and the driving force generator 13, whereby the longitudinal acceleration control can be implemented.

Next, the configuration of the vehicle movement control device according to the first embodiment of the present invention will be described with reference to FIG. 2. FIG. 2 is a system block diagram showing the configuration of the vehicle movement control device according to the first embodiment of the present invention.

The vehicle movement control device according to the first embodiment is mounted on a vehicle, and includes: vehicle information acquisition means (vehicle behavior information acquisition unit) 31 that acquires an amount of operation performed by the driver (driver input information), a movement state of the vehicle (vehicle movement information), and surrounding environment information of the vehicle (outside-world information); vehicle movement control calculation means (acceleration control unit) 32 that gives a control command to a braking/driving force actuator; and a wheel braking/driving torque actuator 33 that generates a braking/driving torque on the respective wheels in response to the command from the vehicle movement control calculation means 32.

A steering angle, a master cylinder pressure, an accelerator pedal stroke amount, and the like are input to the vehicle information acquisition means 31 as the driver input information 34, and a vehicle speed, longitudinal acceleration, lateral acceleration, yaw rate, and the like of the vehicle are input as the vehicle movement information 35. Further, a time to collision (TTC) with an obstacle in front of the vehicle is input as the outside-world information 36.

The vehicle movement control calculation means 32 calculates a vehicle movement control amount on the basis of the information obtained from the vehicle information acquisition means 31 and calculates a braking/driving control amount of the wheel braking/driving torque actuator 33.

The wheel braking/driving torque actuator 33 is an actuator that generates braking/driving torque on the respective wheels, and may be a brake actuator that generates a braking torque by pressing a brake pad against a brake disk of each wheel or by pressing a shoe against a drum of each wheel, an engine braking/driving actuator that generates braking/driving torque by transmitting an engine torque generated by an engine to each wheel via the transmission, or a braking/driving motor actuator that generates braking/driving torque by transmitting a motor torque to each wheel.

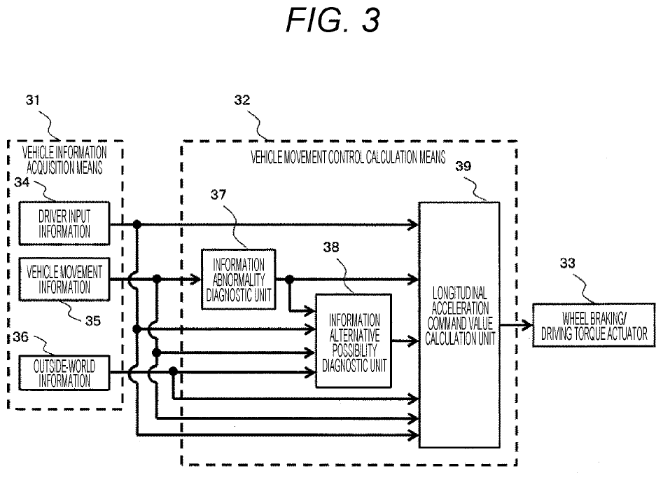

Next, a method of calculating a control command for the wheel braking/driving torque actuator by the vehicle movement control calculation means 32 according to the present invention will be described with reference to FIGS. 3 to 9.

FIG. 3 is a control block diagram of the vehicle movement control calculation means 32 according to the first embodiment of the present invention.

As shown in FIG. 3, the vehicle movement control calculation means 32 includes an information abnormality diagnostic unit (diagnostic unit) 37, an information alternative possibility assessment unit 38, and a longitudinal acceleration command value calculation unit (acceleration control unit) 39.

The information abnormality diagnostic unit 37 diagnoses whether or not each of the information such as the steering angle included in the driver input information 34 and the information such as the lateral acceleration included in the vehicle movement information 35 used in the longitudinal acceleration command value calculation unit 39 is normal. If it is normal, the information abnormality diagnostic unit 37 inputs, to the information alternative possibility assessment unit 38 and the longitudinal acceleration command value calculation unit 39, a diagnostic result indicating that there is no abnormality for each information, and if not normal, the information abnormality diagnostic unit 37 inputs, to the information alternative possibility assessment unit 38 and the longitudinal acceleration command value calculation unit 39, a diagnostic result indicating that there is abnormality for each information.

When the diagnostic result indicating that there is abnormality for each information is input from the information abnormality diagnostic unit 37, the information alternative possibility assessment unit 38 assesses, regarding the information diagnosed to have abnormality, whether or not abrupt steering is performed on the basis of the lateral movement information acquired from the vehicle movement information 35 and the information acquired from the outside-world information 36, and assesses whether or not use of alternative information is possible and whether or not correction of the longitudinal acceleration command value is needed.

The longitudinal acceleration command value calculation unit 39 calculates a longitudinal acceleration command value associated with the lateral movement of the vehicle on the basis of the information acquired from the vehicle information acquisition means 31 and the assessment result of the information abnormality diagnostic unit 37 and the information alternative possibility assessment unit 38.

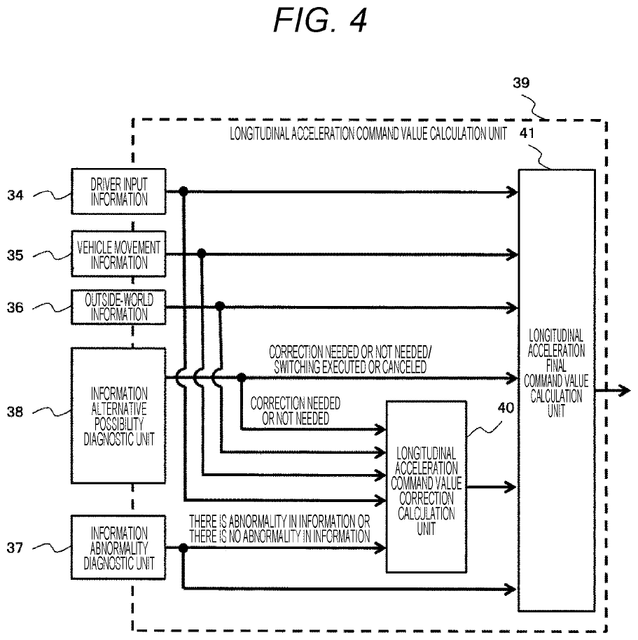

FIG. 4 is a control block diagram of the longitudinal acceleration command value calculation unit 39.

As shown in FIG. 4, the longitudinal acceleration command value calculation unit 39 includes a longitudinal acceleration command value correction calculation unit (command value correction unit) 40 and a longitudinal acceleration final command value calculation unit 41.

The longitudinal acceleration command value correction calculation unit 40 calculates a correction value of the longitudinal acceleration command on the basis of the results of the information abnormality diagnostic unit 37 and the information alternative possibility assessment unit 38, using the driver input information 34, the vehicle movement information 35, and the outside-world information 36, and inputs the result of the calculation to the longitudinal acceleration final command value calculation unit 41.

The longitudinal acceleration final command value calculation unit 41 calculates a final longitudinal acceleration command value on the basis of the results of the information abnormality diagnostic unit 37 and the information alternative possibility assessment unit 38, using the driver input information 34, the vehicle movement information 35, the outside-world information 36, and the result of the longitudinal acceleration command value correction calculation unit 40, and outputs the calculated value.

A flowchart showing an example of diagnosis of whether or not use of alternative information is possible performed by the information alternative possibility assessment unit 38 will be described by way of an example where the steering angle input from the driver input information 34 is diagnosed to have abnormality and is replaced by a yaw rate which is alternative information. Here, it is assumed that a lateral jerk necessary for calculating the longitudinal acceleration command value is calculated from the steering angle. However, the vehicle movement information from which the lateral jerk can be calculated, such as a roll rate and lateral acceleration, may be obviously used. Moreover, although a yaw rate is used as the alternative information of a steering angle, the vehicle movement information from which the lateral jerk can be calculated, such as a roll rate or lateral acceleration, can be obviously used as the alternative information.

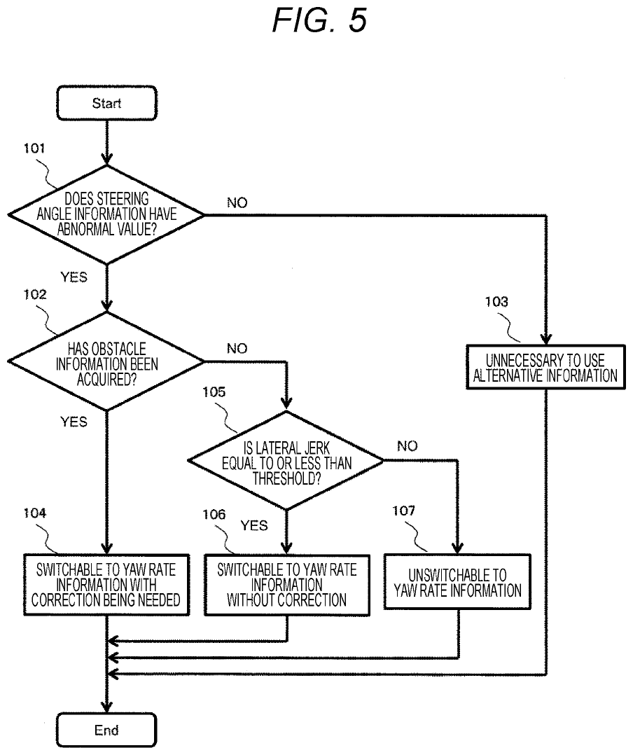

FIG. 5 shows an example of a diagnosis flowchart of the information alternative possibility assessment unit 38 when the steering angle information is diagnosed to have abnormality.

In the flowchart shown in FIG. 5, it is assessed in step 101 whether or not the steering angle information has an abnormal value on the basis of the result of the information abnormality diagnostic unit 37. If the steering angle information has an abnormal value, the process proceeds to step 102, and if not, the process proceeds to step 103.

In step 103, because the result of step 101 shows that the switching to another sensor information is unnecessary, information indicating that correction is “not needed” is output to the longitudinal acceleration command value correction calculation unit 40, and information indicating that correction is “not needed” and the switching is “canceled” is output to the longitudinal acceleration final command value calculation unit 11.

In step 102, it is assessed whether or not obstacle information has been acquired from the outside-world information 36. If acquired, the process proceeds to step 104, and if not, the process proceeds to step 105.

When the obstacle information is acquired before a lateral jerk occurs by the steering operation, the longitudinal acceleration command value can be corrected, even if a phase delay of a yaw rate which is alternative sensor information is great with respect to the steering angle due to abrupt steering. For this reason, it is assessed in step 102 whether or not the obstacle information has been acquired.

In step 104, because the result of step 102 shows that the phase difference between the steering angle and the yaw rate is great but the obstacle information has been acquired, information indicating that correction is “needed” is output to the longitudinal acceleration command value correction calculation unit 40 and information indicating that correction is “needed” and the switching is “executed” is output to the longitudinal acceleration final command value calculation unit 41.

In step 105, the lateral jerk is compared with a predetermined threshold, and if it is equal to or less than the threshold, the process proceeds to step 106, and if it is equal to or greater than the threshold, the process proceeds to step 107.

In step 105, the magnitude of the phase difference (time delay) between the steering angle that cannot be obtained due to a sensor malfunction and the yaw rate which is to be used as an alternative sensor value is determined by comparing the lateral jerk generated on the vehicle by the steering operation and a preset arbitrary lateral jerk (threshold) generated upon abrupt steering.

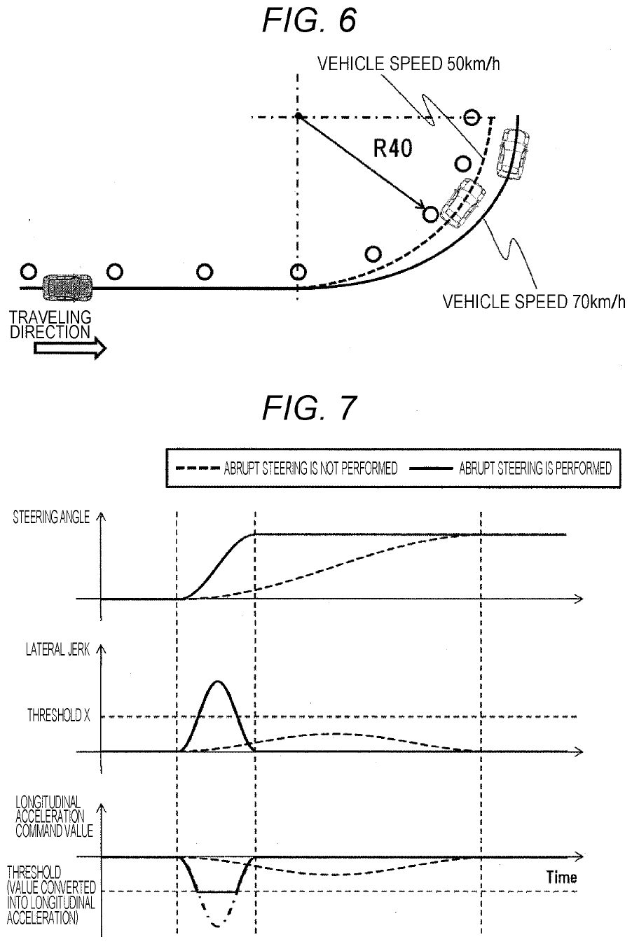

Here, an example of the abrupt steering is shown in FIG. 6.

FIG. 6 is a schematic view of a travel path in a case where, when the friction coefficient μ of the travel road surface (hereinafter referred to as a road surface μ) is high (for example, μ=0.8), the vehicle travels on a curve with a turning radius of 40 m (hereinafter referred to as R40) at the approaching speed of 50 km/h and 70 km/h so as to run along the line of R40 only by the driver's steering operation without an acceleration or brake operation. When the approaching speed is 50 km/h, the vehicle can travel along the line of R40, whereas the vehicle cannot travel along the line of R40 when the approaching speed is 70 km/h, on the basis of the motion performance of the vehicle and the tire. In such a case, in general, the steering amount and the steering angular velocity when the approaching speed is 70 km/h are greater than those when the approaching speed is 50 km/h, and due to an influence of non-linearity of a tire force, a response delay of the yaw rate with respect to the steering angle occurs. Therefore, the peak value of the lateral jerk when the vehicle travels at the maximum approaching speed at which the vehicle can travel along the line of R40 is set as a threshold X used in step 105. When the lateral jerk Y is Y<=X, it is assessed that the phase delay of the yaw rate with respect to the steering angle is small and that the switching to the yaw rate is possible, and when Y>X, it is assessed that the phase delay of the yaw rate with respect to the steering angle is great and that the switching to the yaw rate is impossible. However, when the road surface μ is low (for example, on a compacted snow road), the vehicle speed at which a response delay of the yaw rate to the steering angle occurs is lower than that when the road surface μ is high, due to the influence of the tire force. Therefore, for example, a value of a slip ratio of the tire in the longitudinal direction (traveling direction) calculated using a brush tire model may be successively monitored, and a table in which the threshold of the lateral jerk is varied according to the value may be set. Here, the slip ratio is represented as follows using a speed component u in the direction of the rotating surface of the tire, the dynamic radius R₀ of the tire, and the rotational angular speed ω of the tire. When the vehicle is stopped, it is represented by

$$s = \frac{u - {R}_{0} ω}{u} > 0 \qquad [ Equation 1 ]$$

When the vehicle is traveling, it is represented by

$$s = \frac{u - {R}_{0} ω}{{R}_{0} ω} < 0 \qquad [ Equation 2 ]$$

The relationships between s (road surface μ: high) and s (road surface μ: low) when the vehicle is stopped and when the vehicle is traveling are as follows.

When the vehicle is stopped (s>0),

s (road surface μ: high)<s (road surface μ: low)

When the vehicle is traveling (s<0),

s (road surface μ: high) >s (road surface μ: low)

In step 105, lateral jerk is used as lateral movement information for assessing abrupt steering. However, any factor by which a change rate of the lateral movement can be assessed can be used, such as a yaw angular acceleration, a roll rate, or a derivative value of lateral jerk. Although the vehicle in the first embodiment uses obstacle information that can be acquired from the stereo camera as the outside-world information for predicting abrupt steering, information indicating a curvature of a curve in front of the vehicle, or the like, which can be acquired from navigation information can be used.

Furthermore, although two pieces of information which are the lateral movement information and the outside-world information are used for assessing whether or not switching to alternative information is possible in FIG. 5, the assessment may be made by using only the lateral movement information or only the outside-world information, depending on the vehicle configuration. In step 105, if the lateral jerk is equal to or less than the threshold, the process proceeds to step 106 where the switching to the yaw rate information is possible without adding the correction value. However, the longitudinal acceleration command value may be corrected in order to further improve responsiveness of the longitudinal acceleration control.

In step 106, since the phase difference between the steering angle and the yaw rate is small, information indicating that correction is “not needed” is output to the longitudinal acceleration command value correction calculation unit 40, and information indicating that correction is “not needed” and the switching is “executed” is output to the longitudinal acceleration final command value calculation unit 41.

In step 107, since the result of step 105 shows that the phase difference between the steering angle and the yaw rate is great, and the obstacle information and curvature information have not been acquired, information indicating that correction is “not needed” is output to the longitudinal acceleration command value correction calculation unit 40, and information indicating that correction is “not needed” and the switching is “canceled” is output to the longitudinal acceleration final command value calculation unit 41.

Here, FIG. 7 shows a graph representing an example of the behavior of the longitudinal acceleration command when the longitudinal acceleration control is canceled in step 107.

FIG. 7 shows time-series graphs indicating a steering angle, lateral jerk, and longitudinal acceleration command value when abrupt steering is not performed (dotted line) and when abrupt steering is performed (solid line). The graphs indicating the lateral jerk and longitudinal acceleration command value include the threshold X used to assess whether or not abrupt steering is performed in step 105. In the case of abrupt steering, alternative control is canceled when the lateral jerk becomes equal to or greater than the threshold. However, if it is determined that the alternative control is canceled and the longitudinal acceleration command value is immediately set to 0, the vehicle behavior may be unstable due to a sudden loss of deceleration. In view of this, the deceleration which is constant at the threshold value is generated while the longitudinal acceleration command value is originally generated by the alternative information as indicated in the graph of the longitudinal acceleration command value, for example. With this, a sudden change in the deceleration can be prevented.

Due to the assessment of whether or not the switching to the alternative information is possible as described above, it can be assessed whether or not the longitudinal acceleration control can be continued using the alternative information by assessing a travel scene using the lateral movement information and the outside-world information and performing correction.

A flowchart for assessing whether to execute the correction of the longitudinal acceleration command value by the longitudinal acceleration command value correction calculation unit 40 will be described by way of an example where the steering angle input from the driver input information 34 is diagnosed to have abnormality, as in the diagnosis flowchart of the information alternative possibility assessment unit 38 shown in FIG. 5.

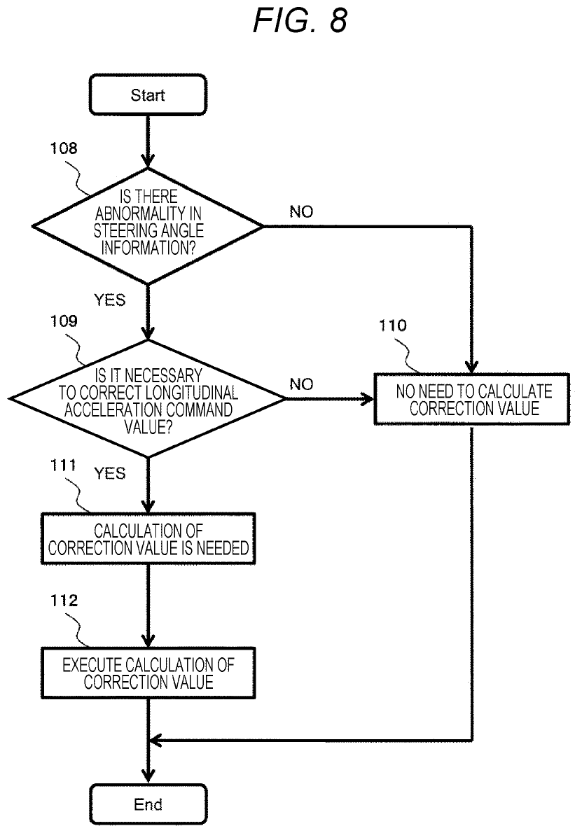

FIG. 8 shows an example of a flowchart showing a flow of calculating a correction value of the longitudinal acceleration command by the longitudinal acceleration command value correction calculation unit 40 when the steering angle information is diagnosed to have abnormality.

In the flowchart shown in FIG. 8, it is assessed in step 108 whether or not there is abnormality in the steering angle information on the basis of the result of the information abnormality diagnostic unit 37. If there is abnormality, the process proceeds to step 109, and if not, the process proceeds to step 110.

In step 109, it is assessed whether or not it is necessary to correct the longitudinal acceleration command value on the basis of the result of the information alternative possibility assessment unit 38. If necessary, the process proceeds to step 111, and if not, the process proceeds to step 110.

In step 110, information indicating that there is “no need” to calculate a correction value is output, because the result of step 108 shows that the steering angle information has no abnormality, and it is unnecessary to correct the longitudinal acceleration command value calculated by the longitudinal acceleration final command value calculation unit 41.

In step 111, information indicating that calculation of the correction value “is needed” is output, because the result of step 109 shows that it is necessary to correct the longitudinal acceleration command value. Then, the process proceeds to step 112.

In step 112, the correction value of the longitudinal acceleration command is calculated on the basis of the result of step 111 using the driver input information 34, the vehicle movement information 35, and the outside-world information 36, and outputs the calculated correction value.

Due to the assessment of whether or not the calculation of the correction value of the longitudinal acceleration command value is needed as described above, the correction value of the longitudinal acceleration command can be calculated only when the longitudinal acceleration command value needs to be corrected, by assessing whether or not there is abnormality in information and whether or not the longitudinal acceleration command value needs to be corrected, on the basis of the information acquired from the information abnormality diagnostic unit 37 and the information alternative possibility assessment unit 38.

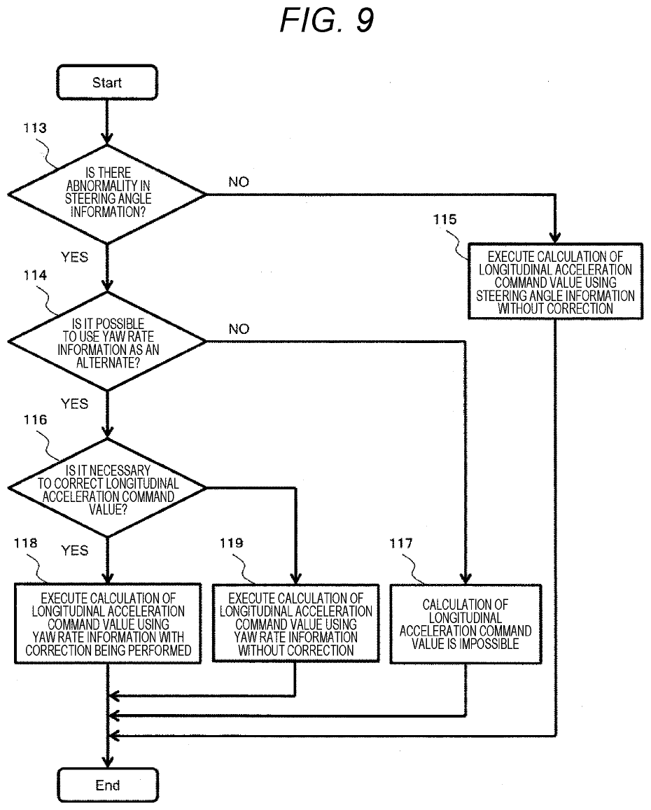

A flowchart for assessing whether to add the correction value to the longitudinal acceleration command value calculated by the longitudinal acceleration final command value calculation unit 41 will be described by way of an example where the steering angle input from the driver input information 34 is diagnosed to have abnormality, as in the diagnosis flowchart of the information alternative possibility assessment unit 38 shown in FIG. 9.

FIG. 9 shows an example of a flowchart showing a calculation flow of the longitudinal acceleration command by the longitudinal acceleration final command value calculation unit 41 when the steering angle information is diagnosed to have abnormality.

In the flowchart shown in FIG. 9, it is assessed in step 113 whether or not there is abnormality in the steering angle information on the basis of the result of the information abnormality diagnostic unit 37. If there is abnormality, the process proceeds to step 114, and if not, the process proceeds to step 115.

In step 114, it is assessed on the basis of the result of the information alternative possibility assessment unit 38 whether or not it is possible to use the yaw rate which is alternative information of the steering angle information as an alternate. If it is possible, the process proceeds to step 116, and if not, the process proceeds to step 117.

In step 116, it is assessed on the basis of the result of the information alternative possibility assessment unit 38 whether or not it is necessary to correct the longitudinal acceleration command value. If it is necessary, the process proceeds to step 118, and if not, the process proceeds to step 119.

In step 115, the longitudinal acceleration command value is calculated using the steering angle information without performing correction as usual, because there is no abnormality in the steering angle information.

In step 117, it is assessed that the calculation of the longitudinal acceleration command value is impossible because the steering angle information has abnormality and using a yaw rate which is alternative information as an alternate is impossible. That is, in this case, the longitudinal acceleration control is canceled.

In step 118, the calculation of the longitudinal acceleration command value is executed using yaw rate information with correction being performed, because the steering angle information has abnormality, and the use of the yaw rate which is alternative information as an alternate is possible, but the longitudinal acceleration command value needs to be corrected due to a great phase difference between the steering angle and the yaw rate.

In step 119, the calculation of the longitudinal acceleration command value is executed using yaw rate information without performing correction, because the steering angle information has abnormality, the use of the yaw rate which is alternative information as an alternate is possible, and the longitudinal acceleration command value does not need to be corrected due to a small phase difference between the steering angle and the yaw rate.

Due to the longitudinal acceleration final command value being calculated as described above, the longitudinal acceleration command value at which the highest effect of the longitudinal acceleration control can be obtained can be calculated according to situations, by assessing whether or not there is abnormality in information, whether or not the switching to the alternative information is possible, and whether or not the longitudinal acceleration command value needs to be corrected, on the basis of the information acquired from the information abnormality diagnostic unit 37 and the information alternative possibility assessment unit 38.

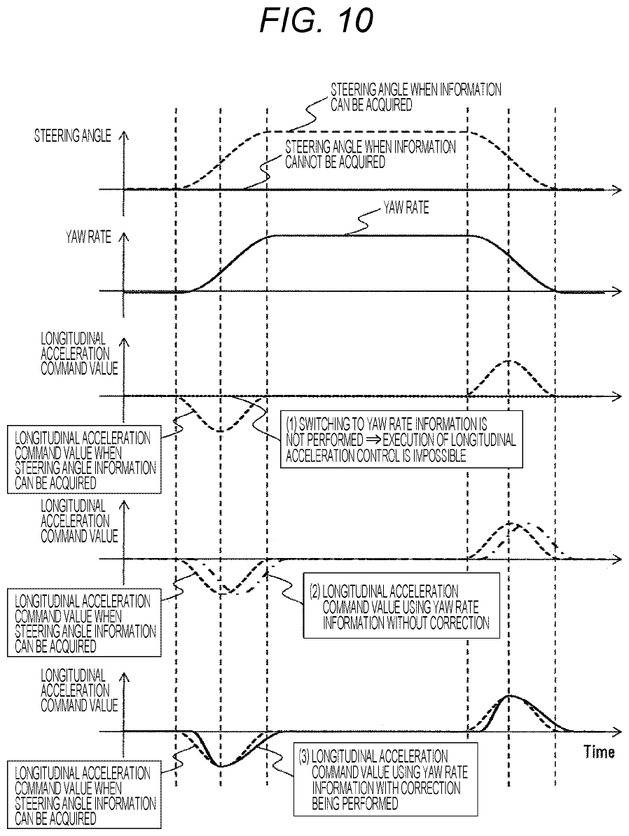

Next, the system configuration described with reference to FIGS. 1 to 9 and the embodiment based on the flowcharts will be described by way of using a specific travel scene with reference to FIGS. 10 to 12.

FIG. 10 is a time-series graph of a steering angle, yaw rate, and longitudinal acceleration command value when information can be acquired and when information cannot be acquired, in a case where the vehicle avoids an obstacle ahead by a steering input. Longitudinal acceleration command values include a longitudinal acceleration command value when steering angle information can be acquired, and longitudinal acceleration command values in the case (1) in which the execution of the longitudinal acceleration control is impossible, in the case (2) in which the longitudinal acceleration control using yaw rate information is performed without correction, and in the case (3) in which the longitudinal acceleration control using yaw rate information is performed with correction being performed.

Here, when the longitudinal acceleration command value is positive, acceleration control is performed, and when the longitudinal acceleration command value is negative, deceleration control is performed.

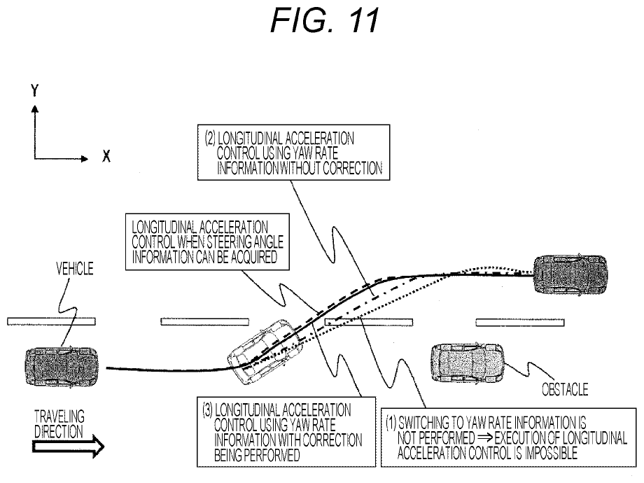

FIG. 11 shows relationship with an obstacle with respect to each travel path in the cases where the longitudinal acceleration control is performed when the steering angle information can be acquired, (1) the execution of the longitudinal acceleration control is impossible, (2) the longitudinal acceleration control using yaw rate information is performed without performing correction, and (3) the longitudinal acceleration control using yaw rate information is performed with correction being performed, when the vehicle travels as shown in FIG. 10.

With the steering as shown in FIG. 10, the travel path as indicated by a dotted line of the case (1) in FIG. 11 is obtained, in the case (1) in FIG. 11 where the execution of the longitudinal acceleration control is impossible, that is, where the present invention is not applied. Next, in the case (2) where the longitudinal acceleration control using yaw rate information is performed without performing correction, that is, when the longitudinal acceleration command value is calculated using the alternative information without performing correction, the distance between the vehicle and the obstacle is increased, as compared with the case (1) in FIG. 11, whereas the avoidance performance is deteriorated as compared with the longitudinal acceleration control when the steering angle information can be acquired. In contrast, when the longitudinal acceleration control using the yaw rate information is performed with correction being performed as in the case (3), that is, when the present invention is applied, the travel path indicated by a solid line of the case (2) in FIG. 11 is obtained. In this travel path, the distance between the vehicle and the obstacle is further increased as compared with the case (2) in FIG. 11, and the effect of improving the avoidance performance equal to that of the longitudinal acceleration control when the steering angle information can be acquired can be obtained.

Here, an example of the method of correcting the longitudinal acceleration command value indicated in the case (3) of FIG. 10 will be described.

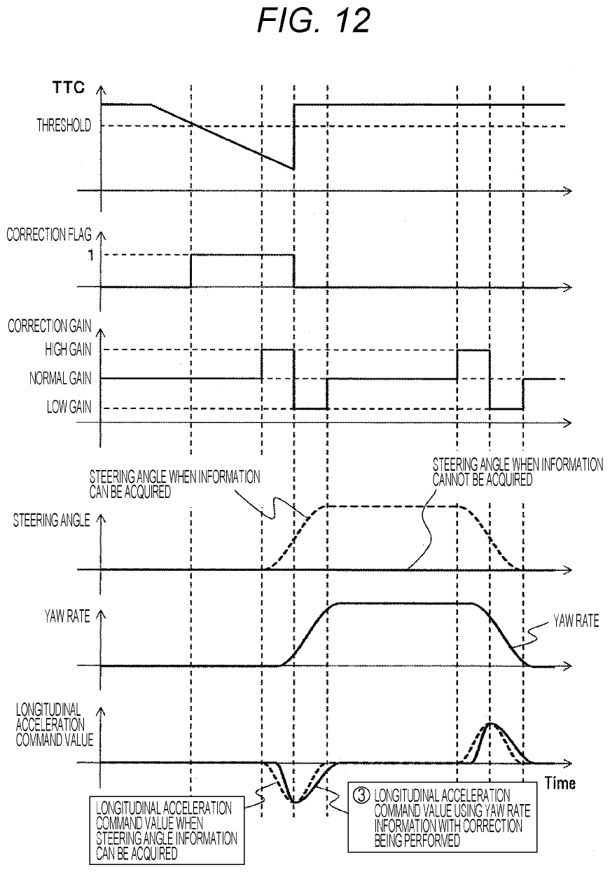

In order to describe the method of correcting the longitudinal acceleration command value indicated in the case (3) of FIG. 10, FIG. 12 shows time series graphs of time-to-collision TTC, correction flag, correction gain, steering angle, yaw rate, and longitudinal acceleration command value.

As shown in FIG. 1, the stereo camera is mounted on the vehicle in the present embodiment, and TTC with an obstacle ahead can be acquired as outside-world information. When the acquired TTC is less than or equal to a preset threshold, the correction flag becomes “1”. When the correction flag is “0”, the gain (=correction gain) of the longitudinal acceleration command value is “normal gain”. When the correction flag is “1” and the absolute value of the longitudinal acceleration command value is increasing, the gain of the longitudinal acceleration command value is a “high gain (>normal gain)”, and when the correction flag is “1” and the absolute value of the longitudinal acceleration command value is decreasing, the gain is a “low gain (<normal gain)”. Due to the correction gain being changed according to TTC as described above, the timings of the peak values of the longitudinal acceleration command values can be made equal to each other between the case where the longitudinal acceleration command value is calculated using a steering angle and the case where the longitudinal acceleration command value is calculated using a yaw rate. This makes it possible to obtain similar effects of the longitudinal acceleration control before and after the switching to the alternative information.

Here, the values of “high gain” and “low gain” of the correction gain may be any predetermined constant, or a map in which, for example, the value of the “high gain” is increased with a decrease in the value of TTC may be used according to a value of TTC (or a curvature of a curve ahead).

When the absolute value of the longitudinal acceleration command value is increasing, the correction gain is changed to a “high gain”. With this, the peak values of the longitudinal acceleration command values before and after the switching to the alternative information can be set equal to each other. However, if the “high gain” is set excessively large, the longitudinal force of the tire increases and reaches a limit of friction circle of a tire force during the longitudinal acceleration control, resulting in that slippage occurs between the tire and the road surface, or the tire may be locked. In view of this, a maximum value may be set to the correction gain so as not to generate an excessive longitudinal acceleration control amount. However, since the limit of friction circle of the tire force varies depending on the road surface μ, the value of the slip ratio represented by [Equation 1] and [Equation 2] may be sequentially monitored to change the maximum value of the correction gain, as described in step 105 of FIG. 5. Further, the maximum value of the correction gain may be an arbitrary constant determined in advance, or a map in which the maximum value of the correction gain varies according to the vehicle speed or the like may be used.

As described above, the present invention can provide: a control device that can provide an effect of the longitudinal acceleration control equal to that before switching to alternative information by assessing whether or not switching to alternative information is possible on the basis of the lateral movement information and the outside-world information, and correcting the alternative information; and a vehicle on which the control device is mounted.

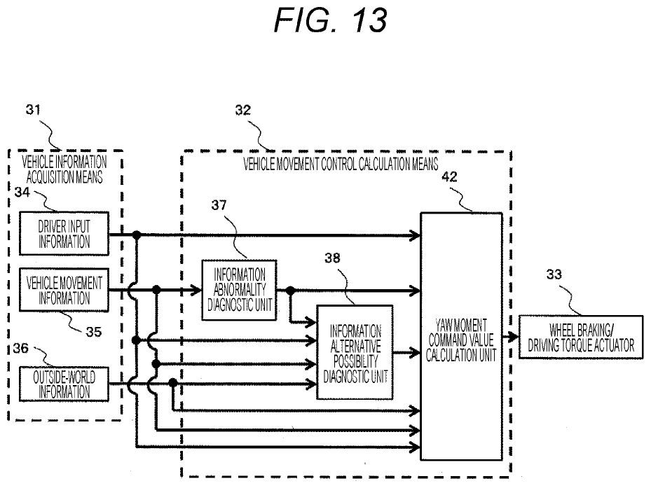

A configuration of a vehicle movement control device to which a vehicle control device according to another embodiment (second embodiment) of the present invention is applied will be described with reference to FIGS. 13 to 16, by way of using, as vehicle movement control calculated on the basis of information acquired from an on-board sensor and information acquired from a vehicle behavior sensor, yaw moment control for generating a yaw moment by applying braking force to inner wheels upon turning a curve (for example, in the case where the vehicle is turning a counterclockwise curve, generating braking force on left wheels upon starting to turn the curve, and generating braking force on right wheels upon exiting the curve) according to lateral movement information (specifically, lateral jerk) acquired from a vehicle behavior sensor.

The configuration of the vehicle control device and the vehicle in the second embodiment are the same as those in the first embodiment. Therefore, refer to FIGS. 1 and 2.

FIG. 13 is a control block diagram of vehicle movement control calculation means 32 according to the second embodiment.

In the vehicle movement control calculation means 32 in the second embodiment, the longitudinal acceleration command value calculation unit 39 in the first embodiment shown in FIG. 3 is replaced by a yaw moment command value calculation unit (yaw moment control unit) 42 as shown in FIG. 13. Therefore, refer to FIGS. 3 to 7 for the information abnormality diagnostic unit 37 and the information alternative possibility assessment unit 38.

The yaw moment command value calculation unit 42 calculates a yaw moment command value associated with the lateral movement of the vehicle on the basis of the information acquired from the vehicle information acquisition means 31 and the diagnostic results of the information abnormality diagnostic unit 37 and the information alternative possibility assessment unit 38.

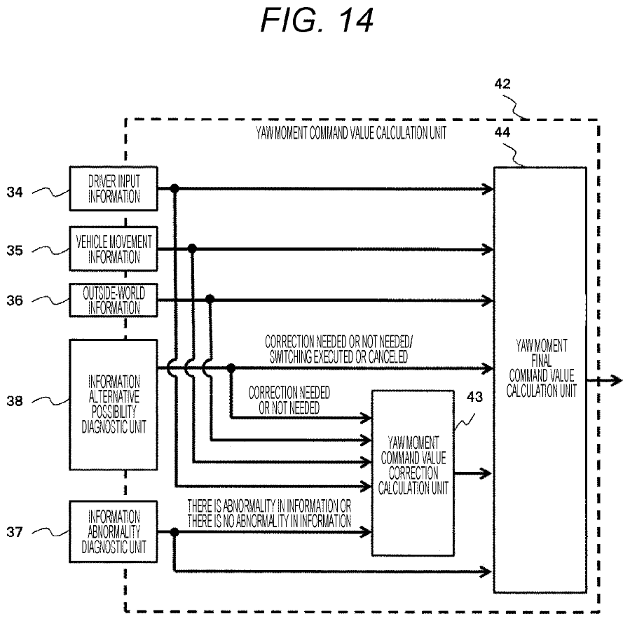

FIG. 14 is a control block diagram of the yaw moment command value calculation unit 42.

As shown in FIG. 14, the yaw moment command value calculation unit 42 includes a yaw moment command value correction calculation unit 43 and a yaw moment final command value calculation unit 44.

The yaw moment command value correction calculation unit (command value correction unit) 43 calculates a correction value of the longitudinal acceleration command on the basis of the results of the information abnormality diagnostic unit 37 and the information alternative possibility assessment unit 38, using the driver input information 34, the vehicle movement information 35, and the outside-world information 36, and inputs the result of the calculation to the yaw moment final command value calculation unit 44.

The longitudinal acceleration final command value calculation unit 44 calculates a final yaw moment command value on the basis of the results of the information abnormality diagnostic unit 37 and the information alternative possibility assessment unit 38, using the driver input information 34, the vehicle movement information 35, the outside-world information 36, and the result of the longitudinal acceleration command value correction calculation unit 40, and outputs the calculated value.

A flowchart for assessing whether to execute the correction of the yaw moment command value by the yaw moment command value correction calculation unit 43 will be described by way of an example where the steering angle input from the driver input information 34 is diagnosed to have abnormality, as in the diagnosis flowchart of the information alternative possibility assessment unit 38 shown in FIG. 5.

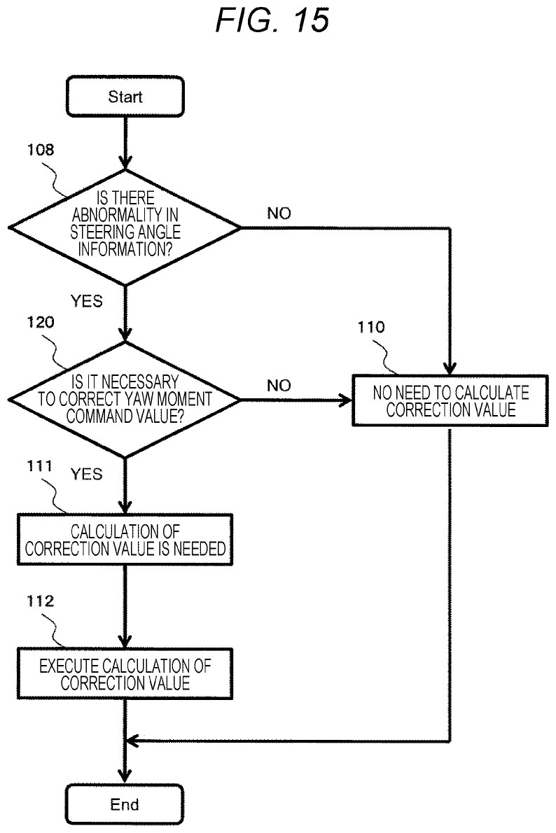

FIG. 15 shows an example of a flowchart showing a flow of calculating a correction value of the yaw moment command by the yaw moment command value correction calculation unit 43 when the steering angle information is diagnosed to have abnormality.

In the flowchart shown in FIG. 15, it is assessed in step 108 whether or not there is abnormality in the steering angle information on the basis of the result of the information abnormality diagnostic unit 37. If there is abnormality, the process proceeds to step 109, and if not, the process proceeds to step 110.

In step 120, it is assessed whether or not it is necessary to correct the yaw moment command value on the basis of the result of the information alternative possibility assessment unit 38. If necessary, the process proceeds to step 111, and if not, the process proceeds to step 110.

In step 110, information indicating that there is “no need” to calculate a correction value is output, because the result of step 108 shows that the steering angle information has no abnormality, and it is unnecessary to correct the longitudinal acceleration command value calculated by the longitudinal acceleration final command value calculation unit 41.

In step 111, information indicating that calculation of the correction value “is needed” is output, because the result of step 120 shows that it is necessary to correct the yaw moment command value. Then, the process proceeds to step 112.

In step 112, the correction value of the yaw moment command is calculated on the basis of the result of step 111 using the driver input information 34, the vehicle movement information 35, and the outside-world information 36, and outputs the calculated correction value.

Due to the assessment of whether or not the calculation of the correction value of the yaw moment command value is needed as described above, the correction value of the yaw moment command can be calculated only when the yaw moment command value needs to be corrected, by assessing whether or not there is abnormality in information and whether or not the yaw moment command value needs to be corrected, on the basis of the information acquired from the information abnormality diagnostic unit 37 and the information alternative possibility assessment unit 38.

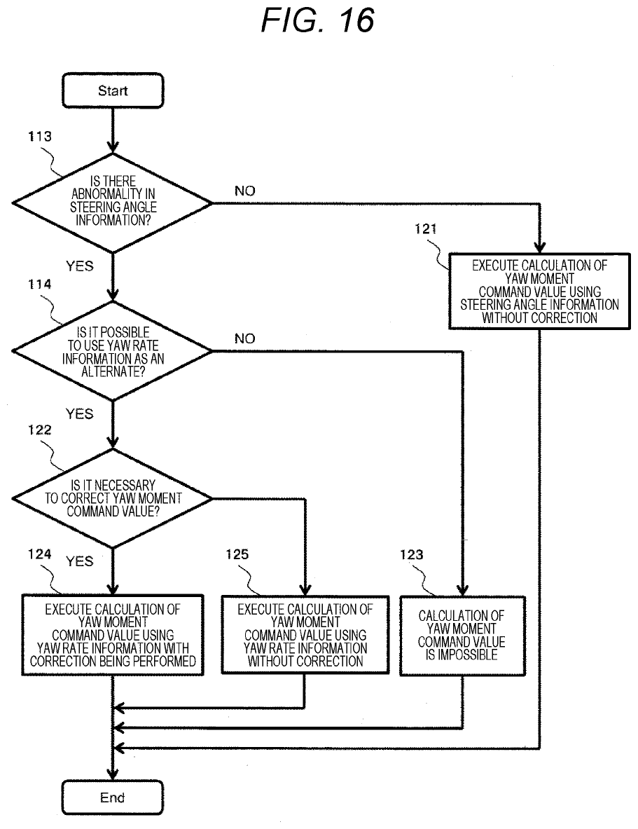

A flowchart for assessing whether to add the correction value to the yaw moment command value calculated by the yaw moment final command value calculation unit 44 will be described by way of an example where the steering angle input from the driver input information 34 is diagnosed to have abnormality, as in the diagnosis flowchart of the information alternative possibility assessment unit 38 shown in FIG. 16.

FIG. 16 shows an example of a flowchart showing a calculation flow of the yaw moment command by the yaw moment final command value calculation unit 44 when the steering angle information is diagnosed to have abnormality.

In the flowchart shown in FIG. 16, it is assessed in step 113 whether or not there is abnormality in the steering angle information on the basis of the result of the information abnormality diagnostic unit 37. If there is abnormality, the process proceeds to step 114, and if not, the process proceeds to step 121.

In step 114, it is assessed on the basis of the result of the information alternative possibility assessment unit 38 whether or not it is possible to use the yaw rate which is alternative information of the steering angle information as an alternate. If it is possible, the process proceeds to step 122, and if not, the process proceeds to step 123.

In step 122, it is assessed on the basis of the result of the information alternative possibility assessment unit 38 whether or not it is necessary to correct the yaw moment command value. If it is necessary, the process proceeds to step 124, and if not, the process proceeds to step 125.

In step 121, the yaw moment command value is calculated using the steering angle information without performing correction as usual, because there is no abnormality in the steering angle information.

In step 123, it is assessed that the calculation of the yaw moment command value is impossible because the steering angle information has abnormality and using a yaw rate which is alternative information as an alternate is impossible. That is, in this case, the yaw moment control is canceled.

In step 124, the calculation of the yaw moment command value is executed using yaw rate information with correction being performed, because the steering angle information has abnormality, and the use of the yaw rate which is alternative information as an alternate is possible, but the yaw moment command value needs to be corrected due to a great phase difference between the steering angle and the yaw rate.

In step 125, the calculation of the yaw moment command value is executed using yaw rate information without performing correction, because the steering angle information has abnormality, the use of the yaw rate which is alternative information as an alternate is possible, and the yaw moment command value does not need to be corrected due to a small phase difference between the steering angle and the yaw rate.

Due to the yaw moment final command value being calculated as described above, the yaw moment command value at which the highest effect of the yaw moment control can be obtained can be calculated according to situations, by assessing whether or not there is abnormality in information, whether or not the switching to the alternative information is possible, and whether or not the yaw moment command value needs to be corrected, on the basis of the information acquired from the information abnormality diagnostic unit 37 and the information alternative possibility assessment unit 38. Further, the timings of the peak values of the yaw rate command values can be set equal to each other between the case where the yaw rate command value is calculated using a steering angle which is information used before the switching to the alternative information is performed and the case where the yaw rate command value is calculated using a yaw rate which is the alternative information in the above embodiment in the same manner as described with reference to FIGS. 10 and 12, whereby an effect similar to the effect shown in FIG. 11 can also be obtained in the yaw moment control.

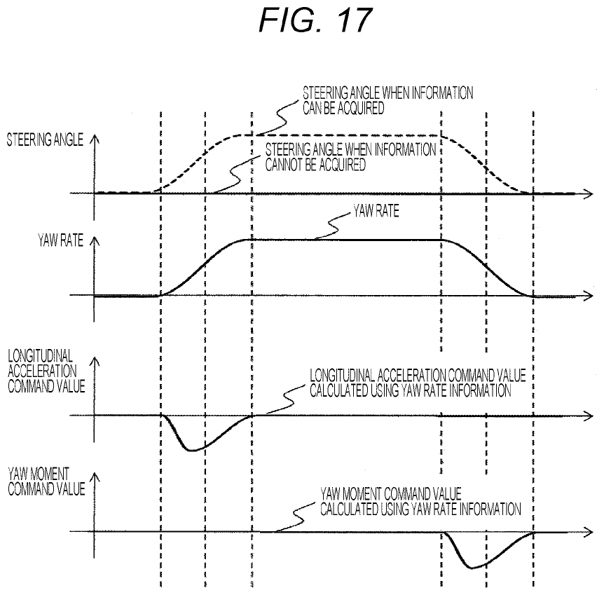

The longitudinal acceleration control according to the first embodiment and the yaw moment control according to the second embodiment have been described above as individual modes. However, the two embodiments can be used together. Specifically, for example, when the lateral acceleration is increasing, that is, when the lateral jerk has a positive value, the longitudinal acceleration control (acceleration control when the value is positive, and deceleration control when the value is negative) is performed, and when the lateral acceleration is decreasing, that is, when the lateral jerk has a negative value, the yaw moment control (counterclockwise moment when the value is positive, and clockwise moment when the value is negative) is performed, as shown in FIG. 17.

According to the above embodiments, a vehicle control device can be provided which, even when information needed to estimate a lateral jerk cannot be detected due to a sensor malfunction or the like, can continue longitudinal acceleration control, according to travel scenes, based on the lateral jerk by correcting the calculation result of the longitudinal acceleration command value calculated using the estimation result of the lateral jerk based on alternative sensor information.

### REFERENCE SIGNS LIST

0 vehicle
5 front-left wheel braking device
6 front-right wheel braking device
7 rear-left wheel braking device
8 rear-right wheel braking device
9 front-left wheel speed sensor
10 front-right wheel speed sensor
11 rear-left wheel speed sensor
12 rear-right wheel speed sensor
13 driving force generating means
17 stereo camera
18 electronic stability control unit
19 longitudinal acceleration control means
20 steering angle sensor
21 accelerator sensor
22 brake sensor
23 lateral acceleration sensor
24 yaw rate sensor
25 roll rate sensor
31 vehicle information acquisition means (vehicle behavior information acquisition unit)
32 vehicle movement control means
33 wheel braking/driving torque actuator
34 driver input information
35 vehicle movement information
36 outside-world information
37 information abnormality diagnostic unit (diagnostic unit)
38 information alternative possibility assessment unit (alternative possibility assessment unit)
39 longitudinal acceleration command value calculation unit (acceleration control unit)
40 longitudinal acceleration command value correction calculation unit (command value correction unit)
41 longitudinal acceleration final command value calculation unit
42 yaw moment command value calculation unit (yaw moment control unit)
43 yaw moment command value correction calculation unit (command value correction unit)
44 yaw moment final command value calculation unit

1. A vehicle control device comprising:
a vehicle behavior information acquisition unit that acquires vehicle behavior information including lateral movement information of a vehicle;
an acceleration control unit that performs acceleration control in accordance with the lateral movement information acquired by the vehicle behavior information acquisition unit;
a diagnostic unit that diagnoses whether there is abnormality in the vehicle behavior information, and outputs diagnostic information; and
an alternative possibility assessment unit that assesses whether alternative control is possible on the basis of the lateral movement information and the diagnostic information.

2. The vehicle control device according to claim 1,
wherein, when abnormality occurs in the vehicle behavior information, the alternative possibility assessment unit assesses whether alternative control to perform the acceleration control is possible on the basis of normal vehicle behavior information.

3. The vehicle control device according to claim 1,
wherein the vehicle behavior information acquisition unit acquires outside-world information, and
the alternative possibility assessment unit assesses whether the alternative control is possible on the basis of the lateral movement information, the diagnostic information, and the outside-world information.

4. The vehicle control device according to claim 1,
wherein the acceleration control unit has a command value correction unit that corrects a command value for performing acceleration control when the alternative possibility assessment unit assesses that alternative control is possible.

5. The vehicle control device according to claim 4,
wherein the command value correction unit corrects the command value by adding a correction gain.

6. The vehicle control device according to claim 5,
wherein the correction gain is determined in advance or generated on the basis of the outside-world information.

7. The vehicle control device according to claim 5,
wherein the correction gain is generated within a range of a predetermined threshold.

8. The vehicle control device according to claim 3,
wherein the alternative possibility assessment unit assesses that the alternative control is possible when the diagnostic unit diagnoses that there is abnormality and obstacle information is acquired from the outside-world information, and
the acceleration control unit corrects a command value for performing the acceleration control.

9. The vehicle control device according to claim 3,
wherein the alternative possibility assessment unit assesses that the alternative control is possible when the diagnostic unit diagnoses that there is abnormality, obstacle information is not acquired from the outside-world information, and the lateral movement information is equal to or less than a predetermined threshold, and
the acceleration control unit performs the acceleration control without correcting a command value for performing the acceleration control.

10. The vehicle control device according to claim 3,
wherein the alternative possibility assessment unit assesses that the alternative control is possible when the diagnostic unit diagnoses that there is abnormality, obstacle information is not acquired from the outside-world information, and the lateral movement information is greater than a predetermined threshold.

11. A vehicle control device comprising:
a vehicle behavior information acquisition unit that acquires vehicle behavior information including lateral movement information of a vehicle;
a yaw moment control unit that performs yaw moment control in accordance with the lateral movement information acquired by the vehicle behavior information acquisition unit;
a diagnostic unit that diagnoses whether there is abnormality in the vehicle behavior information, and outputs diagnostic information; and
an alternative possibility assessment unit that assesses whether alternative control is possible on the basis of the lateral movement information and the diagnostic information.

12. A vehicle control device comprising:
a vehicle behavior information acquisition unit that acquires vehicle behavior information and outside-world information;
an acceleration control unit that performs acceleration control in accordance with the lateral movement information acquired by the vehicle behavior information acquisition unit; and
an alternative possibility assessment unit that assesses whether alternative control is possible on the basis of the vehicle behavior information and the outside-world information.

13. A vehicle control device comprising:
a vehicle behavior information acquisition unit that acquires vehicle behavior information and outside-world information;
an acceleration control unit that performs acceleration control in accordance with the lateral movement information acquired by the vehicle behavior information acquisition unit;
a diagnostic unit that diagnoses whether there is abnormality in the vehicle behavior information, and outputs diagnostic information; and
an alternative possibility assessment unit that assesses whether alternative control is possible on the basis of the outside-world information and the diagnostic information.

14. The vehicle control device according to claim 1,
wherein the alternative possibility assessment unit assesses that the alternative control is impossible when the lateral movement information is equal to or greater than a predetermined value, and
the acceleration control unit cancels the acceleration control when the alternative possibility assessment unit assesses that the alternative control is impossible.

15. The vehicle control device according to claim 1,
wherein the alternative possibility assessment unit assesses that the alternative control is possible when the lateral movement information is less than a predetermined value, and
the acceleration control unit performs or continues the acceleration control when the alternative possibility assessment unit assesses that the alternative control is possible.
